(19) United States
(12) Patent Application Publication
(10) Pub. No.: US 2005/0207948 A1
(43) Pub. Date: Sep. 22, 2005

(54) Catalytic converter with integral heat shield device

(76) Inventor: Hans Borneby, Loudon, TN (US)

Correspondence Address: CARLSON, GASKEY & OLDS, P.C., 400 WEST MAPLE ROAD, SUITE 350, BIRMINGHAM, MI, 48009, US

(21) Appl. No.: 10/802,316

(22) Filed: Mar. 17, 2004

(51) Int. Cl. B01D 53/34

(52) U.S. Cl. 422/179; 29/890; 422/177; 422/180

(57) ABSTRACT

A catalytic converter includes an inner liner housing a catalyst and an outer liner concentric with the inner liner. In one example, the liners are cylindrical tubes arranged between opposing dies during manufacture. The dies are moved toward one another to plastically deform the ends inwardly to form a conical flange. The forming process provides a sealed cavity between the walls of the inner and outer liners that insulates the hot catalyst housed within the inner liner from the environment exterior of the catalytic converter assembly. First and second tapered connecting tubes are welded onto the opposing ends of the catalytic converter in the area of the flange.

### BACKGROUND OF THE INVENTION

This invention relates to a catalytic converter with a heat shield and method of forming a catalytic converter integral with a heat shield.

Catalytic converters are used to reduce harmful emissions from vehicle exhaust. Catalytic converters reach high temperatures, up to 400° C. or more, to achieve the desired chemical reactions necessary to reduce harmful products of combustion. The sooner the catalytic converter reaches the desired operating temperature, the sooner the catalyst can begin converting the product of combustion. Since the catalytic converter reaches high temperatures, it must be insulated from other portions of the vehicle that may be harmed by the heat typically by using a heat shield.

A typical prior art catalytic converter includes two halves that are secured to one another at a seam forming a flange extending about the perimeter of the catalytic converter. This type of configuration results in a relatively flat and wide package that must be located on the underside of the vehicle. A heat shield is then welded to one or more sides of the catalytic converter by brackets. The heat shield typically does not entirely enclose the portion of the catalytic converter containing the catalysts providing poor shielding and insulation.

It is desirable to provide a catalytic converter and heat shield having a shape more suitable for packaging on the underside of the vehicle. It is also desirable to provide a catalytic converter having a heat shield that does not require attachment to the catalytic converter in a separate step during the manufacturing process.

### SUMMARY OF THE INVENTION AND ADVANTAGES

The inventive catalytic converter includes an inner liner housing a catalyst and an outer liner concentric with the inner liner that acts as the heat shield. In one example, the liners are cylindrical tubes. During the catalytic converter manufacturing process, the liners are arranged between opposing dies and the dies are moved toward one another to plastically deform the ends inwardly to form a conical flange. The forming process provides a sealed cavity between the walls of the inner and outer liners that insulates the hot catalyst housed within the inner liner from the environment exterior of the catalytic converter. First and second tapered connecting tubes are welded onto the opposing ends of the catalytic converter in the area of the flange.

In this manner, the present invention provides a catalytic converter and heat shield having a shape more suitable for packaging on the underside of the vehicle, which has a diameter that is not much larger than the tube diameter of the rest of the exhaust system. The inventive manufacturing process provides a catalytic converter with a heat shield that does not require attachment to the catalytic converter in a separate step during the manufacturing process. The inventive heat shield better insulates the catalyst providing earlier light off, reducing harmful emissions.

These and other features of the present invention can be best understood from the following specification and drawings, the following of which is a brief description.

### BRIEF DESCRIPTION OF THE DRAWINGS

FIG. 1 is a schematic view of the inventive manufacturing process used in producing the inventive catalytic converter.

FIG. 2 is a cross-section view of deform catalytic converter liners with the connecting tubes being secured to the ends of the catalytic converter.

FIG. 3 is a cross-sectional view of a fully assembled catalytic converter in accordance with one example of the present invention.

FIG. 4 is an end view of the catalytic converter shown in FIG. 3.

### DETAILED DESCRIPTION OF THE PREFERRED EMBODIMENT

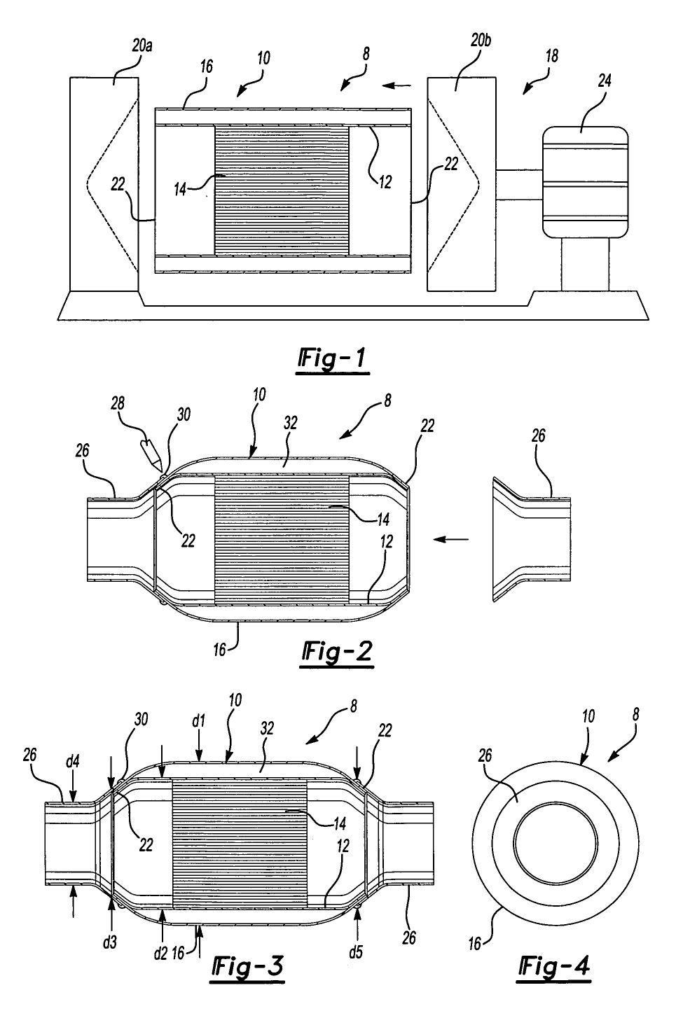

An example of the inventive manufacturing process for the catalytic converter of the present invention is schematically shown in FIG. 1. The catalytic converter 8 includes a center portion 10 having an inner liner 12 housing a catalyst or substrate 14. An outer liner 16 is arranged about the inner liner 12 so that there is space between the liners 12 and 16. The liners 12 and 16 preferably have a circular cross-section and are cylindrical in shape. Furthermore, it is preferable that the liners 12 and 16 are of approximately the same length.

The center portion 10 is arranged between opposing dies 20 of a forming machine 18. The dies 20 have a generally conical recess, but may be of any suitable shape, as will be appreciated by one of ordinary skill in the art. The dies 20 are moved towards one another to plastically deform opposing ends 22 of the center portion 10 inwardly. As the ends 22 are being deformed, the inner liner 12 becomes centered relative to the outer liner 16. The forming machine 18 may include a fixed die 20a and a moveable die 20b that is linearly actuated by a press 24 toward the fixed die 20a.

The ends 22 taper inward forming a flange in which the ends of the liners 12 and 16 overlap and engage one another to provide a sealed cavity 32. The sealed cavity 32 provides a generally uniform air gap arranged circumferentially about the inner liner 12 insulating the substrate 14. In the example shown in FIG. 2, the cavity 32 extends at least the length of the substrate 14 to sufficiently insulate it about its entire length and circumference. The cavity 32 is sealed to minimize heat transfer from the interior of the inner liner 12 to the outer liner 16. The inventive catalytic converter 8 provides improved insulation over prior arrangements which enable quicker light-off of the substrate 14 enabling a desired chemical reaction earlier in vehicle operation.

Connecting tubes 26 having tapered ends are secured to the opposing ends 22, preferably by a weld bead 30 applied by a welder 20a about the circumference of the edge of the connecting tube 26. The weld bead 30 is preferably applied to the edge of the connecting tube where it overlaps the flange to provide sufficient structural rigidity to the joint. Referring to FIG. 3, the outer liner 16 includes a first diameter d1 that is greater than a second diameter d2 of the inner liner. The diameters d1 and d2 have a difference that provide an air gap of approximately ¼ inch or less about the circumference of the inner liner 12. While the air gap may be in a range of approximately ¼ inch to approximately ⅛ inch in one example embodiment, the air gap may be another suitable dimension depending upon the heat generated by the substrate 14 and other variables. The edge of the opposing ends 22 has a third diameter d3 that is greater than a fourth diameter d4 of an opening of the connecting tubes 26. The tapered edge of the connecting tubes 26 where the weld bead 30 is applied preferably includes a diameter d5 that is greater than the third diameter d3 but less than the second diameter d2 so that the tapered edge of the connecting tube 26 is located along the flange.

The present invention provides a compact cylindrical design having an integrated heat shield forming a sealed cavity to provide improved substrate insulation. Furthermore, the inventive catalytic converter is manufactured using a simple process.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of manufacturing a catalytic converter comprising the steps of:
a) placing a first liner into a second liner, the first liner containing a catalyst;
b) plastically deforming opposing ends of the liners into engagement with one another forming a cavity between the liners; and
c) securing first and second connecting tubes to the opposing ends.

2. The method according to claim 1, wherein the liners are cylindrical in shape.

3. The method according to claim 1, wherein step b) forms a conical flange having portions of the first and second liners overlapping and engaging one another.

4. The method according to claim 3, wherein step c) includes welding the connecting tubes to the flanges of the opposing ends.

5. The method according to claim 1, wherein step b) forms a sealed cavity between the first and second liners.

6. The method according to claim 5, wherein the liners are spaced from one another approximately 0.25 inch or less forming an air gap.

7. The method according to claim 6, wherein the air gap extends circumferentially about the first liner and catalyst.

8. A catalytic converter comprising:
a first liner housing a catalyst; and
a second liner arranged about the first liner in spaced relationship therewith forming a sealed cavity providing an air gap about the circumference of the first liner extending at least a length of the catalyst.

9. The catalytic converter according to claim 8, comprising opposing ends of said first and second liners tapered inwardly and in engagement with one another forming said sealed cavity.

10. The catalytic converter according to claim 9, comprising connecting tubes secured to said opposing ends by weld beads.

11. The catalytic converter according to claim 10, wherein said liners and connecting tubes have a generally cylindrical cross-section.
